(19) United States
(12) Patent Application Publication
(10) Pub. No.: US 2023/0235148 A1
(43) Pub. Date: Jul. 27, 2023

(54) METHODS FOR DECOLORIZING COLORED POLYMER MATERIAL AND PREPARING REGENERATED POLYMER, AND DECOLORIZING SOLUTION

(71) Applicant: FAR EASTERN NEW CENTURY CORPORATION, Taipei City (TW)

(72) Inventors: Jia-Ying WU, Taipei City (TW); Ruey-Fen LIAO, Taipei City (TW); Pang-Chin LIU, Taipei City (TW)

(21) Appl. No.: 17/889,079

(22) Filed: Aug. 16, 2022

(30) Foreign Application Priority Data
Jan. 7, 2022 (TW) 111100792

(51) Int. Cl. C08J 11/06; C08J 11/10

(52) U.S. Cl. CPC C08J 11/06; C08J 11/10; C08J 2367/02

(57) ABSTRACT

Disclosed herein is a method for decolorizing a colored polymer material, which includes subjecting the colored polymer material to a first decolorizing treatment with a first decolorizing solution to remove a colorant from the colored polymer material, so as to obtain a first decolorized polymer material and a first used decolorizing solution. A method for preparing a regenerated polymer, and a decolorizing solution are also disclosed.

### CROSS-REFERENCE TO RELATED APPLICATION

This application claims priority of Taiwanese Invention Patent Application No. 111100792, filed on Jan. 7, 2022.

### FIELD

The present disclosure relates to methods for decolorizing a colored polymer material and preparing a regenerated polymer. The present disclosure also relates to a decolorizing solution.

### BACKGROUND

Polyester products (such as polyethylene terephthalate (PET) bottles) have been widely used, and thus, recycling and reuse of the polymer material in the polyester products have become particularly widespread and important. However, these polyester products are colored during manufacturing process thereof, and the colorants present in these polyester products increase the difficulty of recycling and reuse.

US 7192988 B2 discloses a method for removing colorants from a colored polyester, which includes:

(a) depolymerizing the colored polyester by adding a glycol to the colored polyester at a temperature ranging from 180° C. to 280° C. for a time period ranging from 1 hour to 5 hours to produce a glycolyzed monomer; (b) feeding the glycolyzed monomer through a bed of activated carbon (at a temperature above 170° C.) to remove some colorant; and (c) extracting the remaining colorant from the glycolyzed monomer by introducing the glycolyzed monomer to a stirred reactor along with an extraction solvent (such as water, methanol, or glycol). In the depolymerization process, the colorant undergoes a series of thermal decomposition reactions or other side reactions due to the high temperature environment and the presence of catalysts, resulting in a decrease in the adsorption capacity of activated carbon. In addition, activated carbon will selectively adsorb colorants, and different types of activated carbon have different adsorption or desorption effects on various colorants because of different surface pore structures and functional groups.

CN 111607920 A discloses a method for decolorizing a textile material, which includes subjecting the textile material to a decolorizing treatment with water for a time period ranging from 0.5 hour to 8 hours with or without contact with a dye-absorbing material under a hydrothermal condition at a temperature of 100° C. to 170° C. in a decolorization reactor. The dye-absorbing material is selected from the group consisting of activated carbon, cross-linked polystyrene, activated alumina, molecular sieves, and combinations thereof. The weight ratio of the textile material to the dye-absorbing material ranges from 1:0.1 to 1:100. The ratio of the textile material to the water ranges from 1:20 (w/v) to 1:500 (w/v). It can be seen from the examples of CN 111607920 A that the method of CN 111607920 A must be conducted under a condition of high liquor ratio (L.R.) (i.e., the ratio of water to the textile material in decimal form is larger than or equal to 20) in order to obtain the decolorized textile material having a decolorization rate of not lower than 90%. However, such method will cause problems of high cost and environmental pollution.

US 7959807 B2 discloses a method for recovering useful components from a dyed polyester fiber, which includes a dye extraction step, a solid liquid separation step, a depolymerization reaction step, an ester interchange reaction step, and an useful component separation step. The dye extraction step involves extracting and removing a dye at the glass transition temperature of the polyester or higher and at 220° C. or less by an extracting solvent including xylene and alkylene glycol from the dyed polyester fiber. The alkylene glycol may be selected from the group consisting of ethylene glycol, diethylene glycol, 1,3-propanediol, and 1,4-butanediol. In the examples of US 7959807 B2, the dye extraction step is conducted several times using xylene and alkylene glycol, and each extraction step requires a fresh extracting solvent. Therefore, the method of US 7959807 B2 requires a large amount of organic extraction solvents, and has problems of high cost and environmental pollution.

TW 202043347 A discloses a method for recycling a polylactic acid product, which includes subjecting the polylactic acid product having printing ink on the surface thereof to a decolorizing treatment with a decolorizing agent at a temperature ranging from 25° C. to 100° C. for 1 hour. The decolorizing agent includes at least one of a strong basic compound and an organic solvent. The strong basic compound includes sodium hydroxide and potassium hydroxide. The organic solvent includes acetone, butanone, ethanol, isopropanol, ethyl acetate, and toluene. In the examples of TW 202043347 A, the decolorizing agent can be a strong basic compound combined with water and a surfactant, an organic solvent combined with a surfactant, or an organic solvent. In particular, in order to effectively achieve the purpose of decolorization, in the process of the decolorizing treatment, for every 100 g of the polylactic acid product, it is necessary to use 20 g of a strong basic compound combined with 100 g of water and not lower than 20 g of a surfactant, 100 g of an organic solvent combined with a surfactant, or 100 g of an organic solvent. Therefore, the method of TW 202043347 A requires a large amount of organic solvents and strong basic compounds (i.e., every 100 g of the polylactic acid product requires at least 100 g of the decolorizing agent), and has problems of high cost and environmental pollution.

TW 481762 B and TW 202031969 A disclose methods for decolorizing a dye-colored polyester fiber, which include heating a solvent to generate steam, condensing the steam in the dye-colored polyester fiber to form a condensate, and extracting dye from the dye-colored polyester fiber with the condensate. The temperature of the steam is between the glass transition temperature and the melting point of the dye-colored polyester fiber. In order to efficiently extract the dye from the dye-colored polyester fiber, the methods of TW 481762 B and TW 202031969 A requires vaporization of the organic solvent, and the resultant condensate must be maintained at a high temperature (for example, the condensate disclosed in TW 481762 B needs to be maintained at a temperature ranging from 130° C. to 220° C.). Therefore, these two methods have problems of high energy consumption and high cost.

US 5356437 A discloses a process for removing excess dye from a newly manufactured printed or dyed fabric or yarn, which includes treating the fabric or yarn with a wash liquor containing a peroxidase or an oxidase. The method of US 5356437 A lightens the color of the dye by oxidizing the dye on the fabric or yarn, rather than releasing the dye from the fabric or yarn. Since oxidized dyes may be present on the fabric or yarn, during recycling, the oxidized dyes will decompose due to high temperature and produce several substances that are difficult to handle, and thus increases the difficulty of recycling.

US 10640914 B2 discloses a method for decolorizing a dye-colored synthetic polymer, which includes treating the dye-colored synthetic polymer with a treatment composition at a temperature of at least 50° C. The treatment composition has a pH value of not greater than 6, and includes 2.5 g/L to 50 g/L of sodium formaldehyde sulfoxylate, water, and a ketone. A weight ratio of the water to the ketone in the treatment composition ranges from 4:1 to 1:4. A weight ratio of the treatment composition to the dye-colored synthetic polymer ranges from 5:1 to 60:1. The method of US 10640914 B2 must be conducted under a condition of high liquor ratio (L.R.) (i.e., the weight ratio of the water to the dye-colored synthetic polymer) to achieve excellent decolorization effect. Therefore, the method of US 10640914 B2 requires a large amount of the treatment composition, and has problems of high cost and environmental pollution.

JP 2007254904 A discloses a method for decolorizing a recycled polyester fiber product, which includes subjecting a polyester fiber product dyed with an azo-based disperse dye to a treatment with a decoloring treatment solution. The decoloring treatment solution includes 0.05 wt% to 10 wt’s of an alkali agent, 0.1 wt% to 10 wt% of a reducing agent, and a nonionic surfactant. The alkali agent may be selected from the group consisting of sodium hydroxide, sodium carbonate, and potassium hydroxide. The reducing agent may be selected from the group consisting of hydrosulfite and thiourea dioxide. The treatment is conducted at a temperature ranging from 120° C. to 140° C. for a time period ranging from 10 minutes to 180 minutes. The method of JP 2007254904 A must be conducted under a condition of high liquor ratio to achieve the purpose of decolorization. Therefore, the method of JP 2007254904 A requires a large amount of the decoloring treatment solution, and hence has problems of high cost and environmental pollution.

In spite of the aforesaid, there is still a need to develop a method for decolorizing a colored polymer material, which uses a low amount of a decolorizing solution and has excellent decolorizing effects.

### SUMMARY

Therefore, in a first aspect, the present disclosure provides a method for decolorizing a colored polymer material, which can alleviate at least one of the drawbacks of the prior art. The method includes:

subjecting the colored polymer material to a first decolorizing treatment with a first decolorizing solution to remove a colorant from the colored polymer material, so as to obtain a first decolorized polymer material and a first used decolorizing solution.

The first decolorizing treatment is conducted at a temperature of not less than 100° C. for a time period of not less than 30 minutes.

The first decolorizing solution is selected from the group consisting of an unused decolorizing solution, a used decolorizing solution, and a decolorized solution, and includes water, a ketone solvent, and a base.

In the first decolorizing solution, the base is present in an amount ranging from 2 g to 10 g, and the ketone solvent is present in an amount of not lower than 30 mL, based on 1 L of water.

A weight ratio of water to the colored polymer material is not lower than 5.

The used decolorizing solution is obtained by subjecting the colored polymer material to at least one decolorizing treatment with the unused decolorizing solution or the decolorized solution.

The decolorized solution is obtained by subjecting the used decolorizing solution to a distillation treatment so as to obtain a distillate containing water and a ketone solvent, followed by mixing with a component containing a base.

In a second aspect, the present disclosure provides a method for preparing a regenerated polymer, which can alleviate at least one of the drawbacks of the prior art. The method includes:

subjecting a decolorized polymer material which is prepared by the aforesaid method to a recycling treatment which is selected from the group consisting of a physical recycling treatment and a chemical recycling treatment.

In a third aspect, the present disclosure provides a decolorizing solution, which can alleviate at least one of the drawbacks of the prior art, and which includes water, a ketone solvent, and a base.

In the decolorizing solution, the base is present in an amount ranging from 2 g to 10 g, and the ketone solvent is present in an amount of not lower than 30 mL, based on 1 L of water.

### BRIEF DESCRIPTION OF THE DRAWINGS

Other features and advantages of the disclosure will become apparent in the following detailed description of the embodiments with reference to the accompanying drawings, of which:

FIG. 1 is a flow chart illustrating a method for decolorizing a colored polymer material according to the present disclosure;

FIG. 2 is a flow chart illustrating Examples 1 to 33 of the method according to the present disclosure;

FIG. 3 is a flow chart illustrating Examples 34 to 35 of the method according to the present disclosure;

FIG. 4 is a flow chart illustrating Examples 36 to 37 of the method according to the present disclosure;

FIG. 5 is a flow chart illustrating Example 38 of the method according to the present disclosure;

FIG. 6 is a flow chart illustrating Example 39 of the method according to the present disclosure; and

FIG. 7 is a flow chart illustrating Example 40 of the method according to the present disclosure.

### DETAILED DESCRIPTION

### Method for Decolorizing Colored Polymer Material

The present disclosure provides a method for decolorizing a colored polymer material, which includes:

subjecting the colored polymer material to a first decolorizing treatment with a first decolorizing solution to remove a colorant from the colored polymer material, so as to obtain a first decolorized polymer material and a first used decolorizing solution.

The first decolorizing treatment is conducted at a temperature of not less than 100° C. for a time period of not less than 30 minutes.

The first decolorizing solution is selected from the group consisting of an unused decolorizing solution, a used decolorizing solution, and a decolorized solution, and includes water, a ketone solvent, and a base.

In the first decolorizing solution, the base is present in an amount ranging from 2 g to 10 g, and the ketone solvent is present in an amount not lower than 30 mL, based on 1 L of water.

A weight ratio of water to the colored polymer material is not lower than 5.

The used decolorizing solution is obtained by subjecting the colored polymer material to at least one decolorizing treatment with the unused decolorizing solution or the decolorized solution.

The decolorized solution is obtained by subjecting the used decolorizing solution to a distillation treatment so as to obtain a distillate containing water and a ketone solvent, followed by mixing with a component containing a base.

By virtue of the conditions of the first decolorizing treatment and the first decolorizing solution, the first decolorized polymer material prepared by the method according to the present disclosure has a low chromaticity and a high decolorization rate. The method according to the present disclosure can obtain a first decolorized polymer material having a high decolorization rate by using a low amount of the first decolorizing solution. According to the method of the present disclosure, the colored polymer material can be directly subjected to a decolorizing treatment without additional depolymerization treatment. In addition, the phenomenon of back-staining will not occur during the decolorizing treatment, even if the used decolorizing solution is introduced. Therefore, the method of the present disclosure has the advantages of excellent decolorization effect and low cost, and can reduce environmental pollution caused by the first decolorizing solution.

### Colored Polymer Material

According to the present disclosure, the colored polymer material may be made of a natural polymer or a synthetic polymer. An example of the natural polymer may include, but is not limited to, cellulose (such as cotton or linen). Examples of the synthetic polymer may include, but are not limited to, a polyamide (such as nylon) and a polyester (such as a crystallizable polyester). The crystallizable polyester is made by subjecting a component containing a dibasic carboxyl group (—COO) material and a diol to a polymerization reaction. Examples of the dibasic carboxyl group material may include, but are not limited to, an aromatic dicarboxylic acid compound, an aromatic dicarboxylic acid ester compound, and an aromatic dicarboxylic acid anhydride compound. An example of the aromatic dicarboxylic acid compound may include, but is not limited to, an aromatic dicarboxylic acid compound having 8 to 14 carbon atoms. Examples of the aromatic dicarboxylic acid compound having 8 to 14 carbon atoms may include, but are not limited to, terephthalic acid, isophthalic acid, phthalic acid, 2,6-naphthalene dicarboxylic acid, and sodium 5-sulfoisophthalate.

An example of the aromatic dicarboxylic acid ester compound may include, but is not limited to, an aromatic dicarboxylic acid ester compound having 8 to 14 carbon atoms. An example of the aromatic dicarboxylic acid ester compound having 8 to 14 carbon atoms may include, but is not limited to, an alkyl phthalate. Examples of the alkyl phthalate may include, but are not limited to, monoalkyl terephthalate and dialkyl terephthalate. An example of the aromatic dicarboxylic acid anhydride compound may include, but is not limited to, an aromatic dicarboxylic acid anhydride compound having 8 to 14 carbon atoms. Examples of the aromatic dicarboxylic acid anhydride compound having 8 to 14 carbon atoms may include, but are not limited to, terephthalic anhydride and phthalic anhydride.

In certain embodiments, the dibasic carboxyl group material may be selected from the group consisting of terephthalic acid, terephthalic anhydride, isophthalic acid, dimethyl isophthalate, dimethyl phthalate, phthalic anhydride, 2,6-naphthalene dicarboxylic acid, and sodium 5-sulfoisophthalate.

In certain embodiments, the diol may be selected from the group consisting of ethylene glycol, propylene glycol, butylene glycol, neopentyl glycol, pentylene glycol, hexylene glycol, octane glycol, decane glycol, cyclohexanedimethanol, and diethylene glycol.

In certain embodiments, the colored polymer material may be made of a polymer selected from the group consisting of a polyester, a cellulose, a polyamide, and combinations thereof.

In certain embodiments, the colored polymer material may be made of a polymer selected from the group consisting of polyethylene terephthalate (PET), polybutylene terephthalate (PBT), polytrimethylene terephthalate (PTT), poly(1,4-cyclohexylene dimethylene terephthalate) (PCT), and polyethylene 2,6-naphthalate (PEN).

In certain embodiments, the colored polymer material may be made of a polymer selected from the group consisting of PET, PBT, PTT, and combinations thereof.

In an exemplary embodiment, the colored polymer material is made of nylon. In another exemplary embodiment, the colored polymer material is made of cotton. In yet another exemplary embodiment, the colored polymer material is made of linen.

The suitable form of the colored polymer material may include, but is not limited to, a colored polyester fiber, a colored polyester fabric, a colored polyester flake, and a colored polyester resin.

According to the present disclosure, the colored polyester flake may be a polyester flake formed by pulverizing a colored polyester container (such as a PET bottle).

The colorant present in the colored polymer material may include, but are not limited to, a pigment and a dye.

The pigment may include, but are not limited to, an organic pigment and an inorganic pigment.

The dye may include, but are not limited to, a disperse dye, a cationic dye, and an optical brightener.

The disperse dye may include, but are not limited to, a benzyl azo dyes, a heterocyclic azo dye, an anthraquinone dye, and a condensation dye. The condensation dye may include, but are not limited to, quinophthalone, a styryl dye, and coumarin. The disperse dye is not particularly limited, and may be obtained as commercial products, such as Cat. No. XF-19, Cat. No. CBN-356, Cat. No. RV-SF 300, and Cat. No. XF-284 (that are purchased from Chung Fu Dyestuffs Co., Ltd.).

The organic pigment may include, but are not limited to, anthraquinone pigments, perylene pigments, azo pigments, and lactamide pigments.

The inorganic pigment may include, but are not limited to, carbon black, titanium oxide, zinc white, metal sulfides, sulfates, metal hydroxides, and metal carbonates. The metal sulfide may include, but are not limited to, zinc sulfide and cadmium yellow. The sulfate may include, but are not limited to, barium sulfate and lead sulfate.

### Decolorizing Treatment and Decolorizing Solution

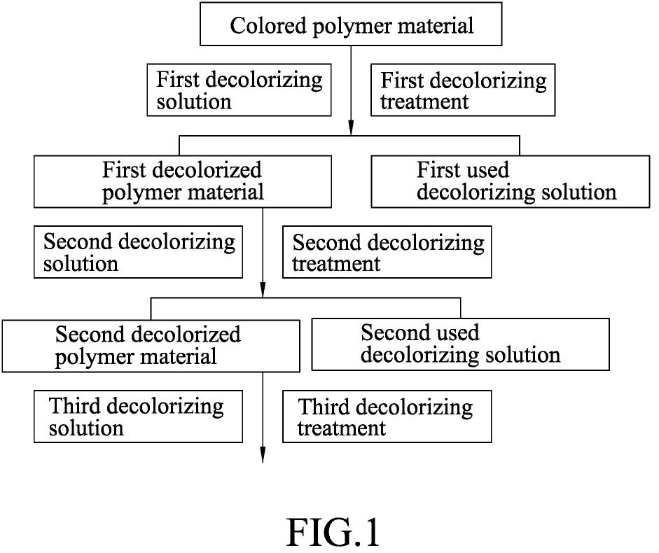

FIG. 1 illustrates the process of the method for decolorizing a colored polymer material according to the present disclosure. As shown in FIG. 1, the method includes subjecting the colored polymer material to a first decolorizing treatment with a first decolorizing solution, a second decolorizing treatment with a second decolorizing solution, and a third decolorizing treatment with a third decolorizing solution in sequence.

In comparison with conventional methods (such as Comparative Examples 2 to 18, infra), in the method for decolorizing a colored polymer material according to the present disclosure, the first decolorizing treatment can impart an excellent decolorization effect. The second decolorizing treatment or the third decolorizing treatment is a non-essential step, and the second decolorizing treatment or the third decolorizing treatment can be selectively performed according to the color properties (such as chromaticity or shade) required by the users in the polymer field.

Moreover, the first decolorizing solution, the second decolorizing solution, and the third decolorizing solution may be the same or different. The operation conditions of the first decolorizing treatment, the second decolorizing treatment, and the third decolorizing treatment may also be the same or different. In addition, in the method for decolorizing a colored polymer material according to the present disclosure, the decolorizing treatment may be performed 3 to 6 times according to the color properties (such as chromaticity or shade) required by the users in the polymer field.

### First Decolorizing Treatment

According to the present disclosure, the first decolorizing treatment is conducted by contacting the colored polymer material with a first decolorizing solution, so as to obtain a first decolorized polymer material and a first used decolorizing solution.

In order to achieve good decolorization effect and operational safety, and to avoid excessive energy consumption, the first decolorizing treatment may be conducted at a temperature ranging from 100° C. to 150° C. In certain embodiments, the first decolorizing treatment is conducted at a temperature ranging from 100° C. to 130° C.

In order to achieve good decolorization effect and avoid excessive energy consumption, the first decolorizing treatment may be conducted for a time period ranging from 30 minutes to 180 minutes. In certain embodiments, the first decolorizing treatment is conducted for a time period ranging from 30 minutes to 90 minutes. In certain embodiments, the first decolorizing treatment is conducted for a time period ranging from 30 minutes to 60 minutes.

### Second Decolorizing Treatment

According to the present disclosure, the second decolorizing treatment is conducted by contacting the first decolorized polymer material with a second decolorizing solution, so as to obtain a second decolorized polymer material and a second used decolorizing solution.

According to the present disclosure, the second decolorizing treatment may be conducted at a temperature of not lower than 100° C. for a time period of not lower than 30 minutes. In certain embodiments, the second decolorizing treatment is conducted at a temperature ranging from 100° C. to 150° C. In certain embodiments, the second decolorizing treatment is conducted at a temperature ranging from 100° C. to 130° C. In certain embodiments, the temperature of the second decolorizing treatment is not greater than the temperature of the first decolorizing treatment.

According to the present disclosure, the second decolorizing treatment may be conducted for a time period ranging from 30 minutes to 90 minutes. In certain embodiments, the second decolorizing treatment is conducted for a time period ranging from 30 minutes to 60 minutes.

### Third Decolorizing Treatment

According to the present disclosure, the third decolorizing treatment is conducted by contacting the second decolorized polymer material with a third decolorizing solution, so as to obtain a third decolorized polymer material and a third used decolorizing solution.

According to the present disclosure, the third decolorizing treatment may be conducted at a temperature of not lower than 100° C. for a time period of not lower than 30 minutes. In certain embodiments, the third decolorizing treatment is conducted at a temperature ranging from 100° C. to 150° C. In certain embodiments, the third decolorizing treatment is conducted at a temperature ranging from 100° C. to 130° C. In certain embodiments, the temperature of the third decolorizing treatment is not greater than the temperatures of the first decolorizing treatment and the second decolorizing treatment.

According to the present disclosure, the third decolorizing treatment may be conducted for a time period ranging from 30 minutes to 90 minutes. In certain embodiments, the third decolorizing treatment is conducted for a time period ranging from 30 minutes to 60 minutes.

### First Decolorizing Solution

### Water

In certain embodiments, the weight ratio of water to the colored polymer material is not lower than 5 and lower than 50. In certain embodiments, the weight ratio of water to the colored polymer material ranges from 5:1 to 20:1. In certain embodiments, the weight ratio of water to the colored polymer material ranges from 10:1 to 20:1.

### Base

According to the present disclosure, the base is used to destroy the colorant in the colored polymer material, so as to remove the colorant from the colored polymer material. In certain embodiments, the base is present in an amount ranging from 2 g to 7 g, based on 1 L of water. In certain embodiments, the base is present in an amount ranging from 4 g to 7 g, based on 1 L of water.

Any base capable of making the pH value of the decolorizing solution greater than 7 may be used in the present disclosure. Examples of the base may include, but are not limited to, an alkali metal hydroxide and an alkali metal carbonate. An example of the alkali metal hydroxide may include, but is not limited to, sodium hydroxide. Examples of the alkali metal carbonate may include, but are not limited to, sodium carbonate and sodium bicarbonate. In certain embodiments, in order for the method for decolorizing a colored polymer material to exert good decolorization effect, the base is an alkali metal hydroxide.

### Ketone Solvent

According to the present disclosure, the ketone solvent is used to swell the colored polymer material and dissolve the colorant, so that the colorant can be released from the colored polymer material.

In certain embodiments, in order for the method for decolorizing a colored polymer material to exert good decolorization effect and reduce the amount of the ketone solvent so as to avoid environmental pollution, the ketone solvent is present in an amount ranging from 30 mL to 1000 mL, based on 1 L of water. In certain embodiments, the ketone solvent is present in an amount ranging from 45 mL to 1000 mL, based on 1 L of water. In certain embodiments, the ketone solvent is present in an amount ranging from 45 mL to 995 mL, based on 1 L of water. In certain embodiments, the ketone solvent is present in an amount ranging from 45 mL to 700 mL, based on 1 L of water. In certain embodiments, the ketone solvent is present in an amount ranging from 45 mL to 600 mL, based on 1 L of water.

Examples of the ketone solvent may include, but are not limited to, acetone, butanone, cyclopentanone, diisobutyl ketone, dipropyl ketone, and cyclohexanone. In certain embodiments, the ketone solvent is selected from the group consisting of acetone, butanone, cyclohexanone, and combinations thereof. In certain embodiments, in order for the method for decolorizing a colored polymer material to exert good decolorization effect and reduce the amount of the ketone solvent so as to avoid environmental pollution, the ketone solvent is selected from the group consisting of butanone, cyclohexanone, and a combination thereof.

In certain embodiments, the first decolorizing solution further includes sodium dithionite (Na₂S₂O₄). In certain embodiments, sodium dithionite is present in an amount ranging from 1 g to 10 g, based on 1 L of water.

According to the present disclosure, the first decolorizing solution may be selected from the group consisting of an unused decolorizing solution, a used decolorizing solution, and a decolorized solution.

According to the present disclosure, the used decolorizing solution is obtained by subjecting the colored polymer material to at least one decolorizing treatment with the unused decolorizing solution or the decolorized solution. Examples of the used decolorizing solution may include, but are not limited to, a first used decolorizing solution, a second used decolorizing solution, and a third used decolorizing solution. In certain embodiments, the first decolorizing solution is a second used decolorizing solution.

According to the present disclosure, the decolorized solution is obtained by subjecting the used decolorizing solution to a distillation treatment to obtain a distillate containing water and a ketone solvent, followed by mixing with a component containing a base. In the distillation treatment, water and the ketone solvent in the used decolorizing solution are subjected to an azeotropic distillation. The distillate does not need to be subjected to a purification process or a separation process, and can be directly mixed with the component containing a base, and can be used in the decolorizing treatment as a decolorizing solution. In certain embodiments, the first used decolorizing solution is collected, and is then subjected to the distillation treatment. The distillate is clear and colorless, and is free from a colorant. The temperature range of the distillation treatment may be adjusted according to the type and content of the ketone solvent in the used decolorizing solution.

In certain embodiments, the distillation treatment is conducted at a temperature ranging from 65° C. to 105° C. In certain embodiments, the ketone solvent is present in an amount ranging from 30 wt% to 95 wt%, based on 100 wt% of the distillate. In certain embodiments, when the ketone solvent is butanone, the butanone is present in an amount ranging from 80 wt% to 95 wt%, based on 100 wt% of the distillate, and the distillation treatment is conducted at a temperature ranging from 65° C. to 80° C. In certain embodiments, when the ketone solvent is cyclohexanone, the cyclohexanone is present in an amount ranging from 30 wt% to 50 wt%, based on 100 wt% of the distillate, and the distillation treatment is conducted at a temperature ranging from 90° C. to 100° C. In certain embodiments, when the ketone solvent is cyclopentanone, the cyclopentanone is present in an amount ranging from 50 wt% to 65 wt%, based on 100 wt% of the distillate, and the distillation treatment is conducted at a temperature ranging from 90° C. to 105° C. In certain embodiments, when the ketone solvent is diisobutyl ketone, the diisobutyl ketone is present in an amount ranging from 40 wt% to 55 wt%, based on 100 wt% of the distillate, and the distillation treatment is conducted at a temperature ranging from 90° C. to 105° C. In certain embodiments, when the ketone solvent is dipropyl ketone, the dipropyl ketone is present in an amount ranging from 55 wt% to 65 wt%, based on 100 wt% of the distillate, and the distillation treatment is conducted at a temperature ranging from 90° C. to 100° C. In certain embodiments, the component may further contain water. In certain embodiments, the component is a base or an alkaline aqueous solution containing a base and water.

In certain embodiments, the first decolorizing solution has a pH value greater than 7.

### Second Decolorizing Solution

According to the present disclosure, the second decolorizing solution may be selected from the group consisting of the first decolorizing solution, the first used decolorizing solution, the second used decolorizing solution, and the third used decolorizing solution. In certain embodiments, the second decolorizing solution may be selected from the group consisting of the first decolorizing solution, the first used decolorizing solution, and the third used decolorizing solution.

### Third Decolorizing Solution

According to the present disclosure, the third decolorizing solution may be selected from the group consisting of the first decolorizing solution, the first used decolorizing solution, the second used decolorizing solution, and the third used decolorizing solution. In certain embodiments, the third decolorizing solution may be selected from the group consisting of the first decolorizing solution, the first used decolorizing solution, and the second used decolorizing solution.

### Method for Preparing Regenerated Polymer

The present disclosure also provides a method for preparing a regenerated polymer, which includes:

subjecting a decolorized polymer material to a recycling treatment which is selected from the group consisting of a physical recycling treatment and a chemical recycling treatment.

The decolorized polymer material is formed by a method as described above. In certain embodiments, the decolorized polymer material is made of a synthetic polymer.

According to the present disclosure, the regenerated polymer can be used as a raw material for fabrics, bottles, packaging materials, etc., and hence is capable of achieving the purpose of closed-loop recycling.

### Physical Recycling Treatment

In certain embodiments, the physical recycling treatment is conducted by subjecting the decolorized polymer material to a melting process, followed by a granulation process. The melting process and the granulation process may be performed using techniques well-known to those skilled in the art.

When the decolorized polymer material is subjected to the physical recycling treatment, the impact of the colorant on the physical properties of the regenerated polymer (for example, the reduction in viscosity) can be greatly reduced, so that the regenerated polymer can have an appropriate viscosity to facilitate subsequent applications. In addition, since the regenerated polymer does not contain a colorant and has a good hue, the subsequent application of the regenerated polymer is not limited, and may be beneficially made into a polymer sheet, a polymer container, or a polymer fabric.

### Chemical Recycling Treatment

In certain embodiments, the chemical recycling treatment is conducted by subjecting the decolorized polymer material to a depolymerization reaction, a separation process, and a purification process performed in sequence so as to obtain a component containing a polymerizable monomer, followed by subjecting the component to a polymerization reaction. The depolymerization reaction, the separation process, and the purification process may be performed using techniques well-known to those skilled in the art.

When the decolorized polymer material is subjected to the chemical recycling treatment, the difficulty of the separation and purification processes can be greatly reduced, thereby obtaining a polymerizable monomer having a high purity and a regenerated polymer with good quality (such as purity, viscosity, and hue).

The present disclosure will be further described by way of the following examples. However, it should be understood that the following examples are intended solely for the purpose of illustration and should not be construed as limiting the present disclosure in practice.

### EXAMPLES

### Example 1 (EX1)

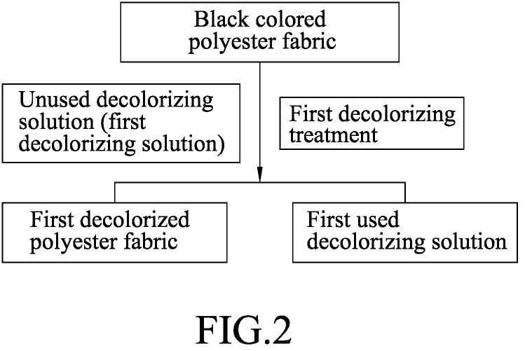

Referring to FIG. 2, 75.4125 g of water, 0.3375 g of sodium hydroxide, and 30 mL of butanone were mixed to obtain an unused decolorizing solution (serving as a first decolorizing solution). The amount of sodium hydroxide was 4.48 g (i.e., (0.3375×1000)/75.4125), and the amount of butanone was 397.81 mL (i.e., (30×1000)/75.4125), based on 1 L of water.

Next, 5 g of a black colored polyester fabric (the weight ratio of water to the black colored polyester fabric was 15.08:1, i.e., 75.4125 g:5 g, and the polyester was polyethylene terephthalate) was immersed in the unused decolorizing solution placed in a pressurized reaction chamber, followed by conducting a first decolorizing treatment, which was performed at 100° C. for 90 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

### Examples 2 to 32 (EX2 to EX32)

The procedures for preparing the first dried decolorized polyester fabrics of EX2 to EX32 were similar to those of EX1, except for the difference in the components and the amounts thereof for making the first decolorizing solution, and the operation conditions for the first decolorizing treatment were varied as shown in Tables 1 and 2 below.

### Example 33 (EX33)

Referring to FIG. 2, 75.4125 g of water, 0.3375 g of sodium hydroxide, 0.225 g of sodium dithionite (Na₂S₂O₄) (serving as a reducing agent), and 30 mL of cyclohexanone were mixed to obtain an unused decolorizing solution (serving as a first decolorizing solution). The amount of sodium hydroxide was 4.48 g (i.e., (0.3375×l000)/75.4125), the amount of cyclohexanone was 397.81 mL (i.e., (30×1000)/75.4125), and the amount of sodium dithionite was 2.98 g (i.e., (0.225×1000)/75.4125), based on 1 L of water.

Next, 5 g of a black colored polyester fabric (the weight ratio of water to the black colored polyester fabric was 15.08:1, i.e., 75.4125 g:5 g, and the polyester was polyethylene terephthalate) was immersed in the unused decolorizing solution placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

### Example 34 (EX34)

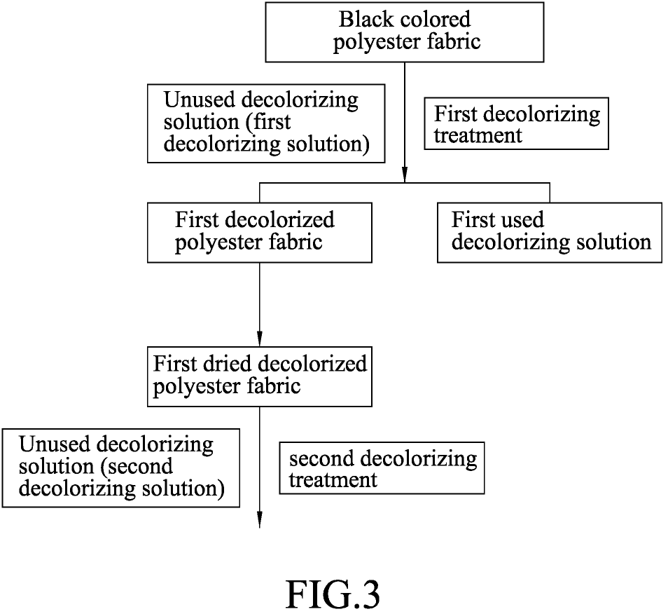

Referring to FIG. 3, 75.4125 g of water, 0.3375 g of sodium hydroxide, and 30 mL of butanone were mixed to obtain an unused decolorizing solution (serving as a first decolorizing solution). The amount of sodium hydroxide was 4.48 g (i.e., (0.3375×1000)/75.4125), and the amount of butanone was 397.81 mL (i.e., (30×1000)/75.4125), based on 1 L of water.

Next, 5 g of a black colored polyester fabric (the weight ratio of water to the black colored polyester fabric was 15.08:1, i.e., 75.4125 g:5 g, and the polyester was polyethylene terephthalate) was immersed in the unused decolorizing solution placed in a pressurized reaction chamber, followed by conducting a first decolorizing treatment, which was performed at 100° C. for 60 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

The first dried decolorized polyester fabric was subjected to a second decolorizing treatment, which was performed according to procedures similar to those described above for the first decolorizing treatment and the aforesaid unused decolorizing solution served as a second decolorizing solution, followed by washing and drying treatments according to the procedures described above, so as to obtain a second dried decolorized polyester fabric.

### Example 35 (EX35)

The procedures for preparing the first and second dried decolorized polyester fabrics of EX35 were similar to those of EX34, except that cyclohexanone was used for making the unused decolorizing solution, and the operation conditions for the first decolorizing treatment were varied as shown in Tables 1 and 2 below.

### Example 36 (EX36)

The first to the third dried decolorized polyester fabrics of EX36 were prepared as follows.

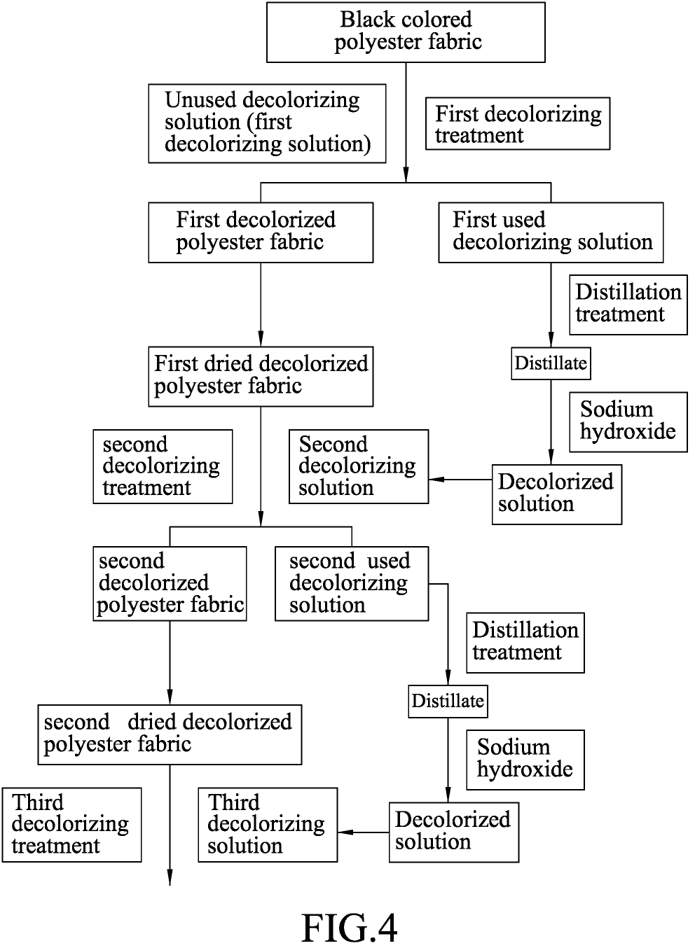

Referring to FIG. 4, in step (a), 75 g of water, 0.3375 g of sodium hydroxide, and 50 mL of cyclohexanone were mixed to obtain an unused decolorizing solution (serving as a first decolorizing solution). The amount of sodium hydroxide was 4.5 g (i.e., (0.3375×1000)/75), and the amount of cyclohexanone was 666.67 mL (i.e., (50×1000)/75), based on 1 L of water.

Next, 5 g of a black colored polyester fabric (the weight ratio of water to the black colored polyester fabric was 15:1, i.e., 75 g:5 g, and the polyester was polyethylene terephthalate) was immersed in the unused decolorizing solution placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

In step (b), the first used decolorizing solution was subjected to a distillation treatment at 98° C. to obtain a transparent and colorless distillate containing water and cyclohexanone. In the distillate, the weight ratio of water to cyclohexanone was 6:4 (i.e., the cyclohexanone was present in an amount of 40 wt%, based on the total weight of the distillate). Next, 125 mL of the distillate and 0.3375 g of sodium hydroxide were mixed to obtain a decolorized solution containing 75 g of water, 0.3375 g of sodium hydroxide, and 50 mL of cyclohexanone. In the decolorized solution, the amount of sodium hydroxide was 4.5 g, and the amount of cyclohexanone was 666.67 mL, based on 1 L of water.

The first dried decolorized polyester fabric obtained in step (a) was immersed in the decolorized solution (serving as a second decolorizing solution) placed in a pressurized reaction chamber, followed by conducting a second decolorizing treatment, which was performed at 130° C. for 60 minutes under a controlled pressure to avoid the leakage of water vapor or gas explosion from the pressurized reaction chamber, so as to obtain a second decolorized polyester fabric and a second used decolorizing solution. Thereafter, the second decolorized polyester fabric was taken out from the second used decolorizing solution, and the second used decolorizing solution remaining on the second decolorized polyester fabric was washed off with water at 25° C., so as to obtain a washed decolorized polyester fabric. The washed decolorized polyester fabric was subjected to a dehydration treatment and a shade drying treatment in sequence so as to obtain a second dried decolorized polyester fabric.

In step (c), the second used decolorizing solution was subjected to a distillation treatment at 98° C. so as to obtain a transparent and colorless distillate containing water and cyclohexanone. In the distillate, the weight ratio of water to cyclohexanone was 6:4. Next, 125 mL of the distillate and 0.3375 g of sodium hydroxide were mixed to obtain a decolorized solution containing 75 g of water, 0.3375 g of sodium hydroxide, and 50 mL of cyclohexanone. In the decolorized solution, the amount of sodium hydroxide was 4.5 g, and the amount of cyclohexanone was 666.67 mL, based on 1 L of water.

The second dried decolorized polyester fabric obtained in step (b) was immersed in the decolorized solution (serving as a third decolorizing solution) placed in a pressurized reaction chamber, followed by conducting a third decolorizing treatment, which was performed at 130° C. for 60 minutes under a controlled pressure to avoid the leakage of water vapor or gas explosion from the pressurized reaction chamber, so as to obtain a third decolorized polyester fabric and a third used decolorizing solution. Thereafter, the third decolorized polyester fabric was taken out from the third used decolorizing solution, and the third used decolorizing solution remaining on the third decolorized polyester fabric was washed off with water at 25° C., so as to obtain a washed decolorized polyester fabric. The washed decolorized polyester fabric was subjected to a dehydration treatment and a shade drying treatment in sequence so as to obtain a third dried decolorized polyester fabric.

### Example 37 (EX37)

The procedures for preparing the first to the third dried decolorized polyester fabrics of EX37 were similar to those of EX36, except that in step (a), 75 g of water, 0.1576 g of sodium hydroxide, and 50 mL of cyclohexanone were mixed to obtain an unused decolorizing solution (serving as a first decolorizing solution), and in steps (b) and (c), 125 mL of the transparent and colorless distillate and 0.1576 g of sodium hydroxide were mixed to obtain a decolorized solution containing 75 g of water, 0.1576 g of sodium hydroxide, and 50 mL of cyclohexanone (the decolorized solution serving as a second decolorizing solution and a third decolorizing solution respectively), as shown in Tables 1 and 2.

### Example 38 (EX38)

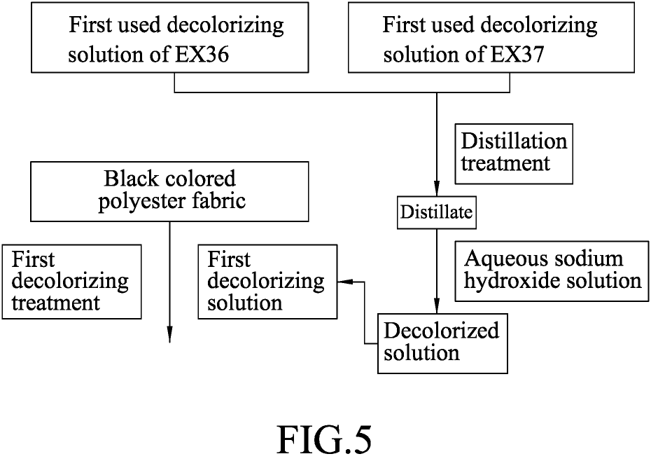

Referring to FIG. 5, the first used decolorizing solution in step (a) of EX36 and the first used decolorizing solution in step (a) of EX37 were mixed to obtain a mixture. Then, 250 mL of the mixture was subjected to a distillation treatment at 98° C. to obtain a transparent and colorless distillate containing water and cyclohexanone. In the distillate, the weight ratio of water to cyclohexanone was 6:4. Next, 125 mL of the distillate and 0.75 g of an aqueous sodium hydroxide solution containing 45 wt% of sodium hydroxide were mixed to obtain a decolorized solution containing 75.4125 g of water, 0.3375 g of sodium hydroxide, and 50 mL of cyclohexanone. In the decolorized solution, the amount of sodium hydroxide was 4.48 g, and the amount of cyclohexanone was 663.02 mL, based on 1 L of water.

Next, 5 g of a black colored polyester fabric (the weight ratio of water to the black colored polyester fabric was 15.08:1, i.e., 75.4125 g:5 g, and the polyester was polyethylene terephthalate) was immersed in the decolorized solution (serving as a first decolorizing solution) placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

### Example 39 (EX39)

The first to the third dried decolorized polyester fabrics of EX39 were prepared as follows.

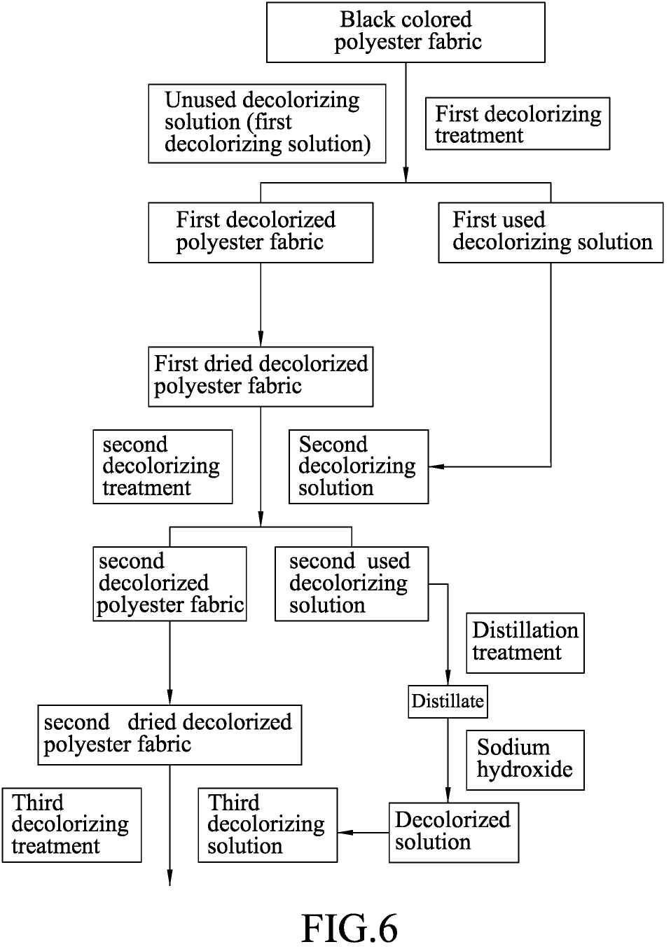

Referring to FIG. 6, in step (a), 75.1925 g of water, 0.1575 g of sodium hydroxide, and 50 mL of cyclohexanone were mixed to obtain an unused decolorizing solution (serving as a first decolorizing solution). The amount of sodium hydroxide was 2.09 g (i.e., (0.1575×1000)/75.1925), and the amount of cyclohexanone was 664.96 mL (i.e., (50×1000)/75.1925), based on 1 L of water.

Next, 5 g of a black colored polyester fabric (the weight ratio of water to the black colored polyester fabric dye was 15.04:1, i.e., 75.1925 g:5 g, and the polyester was polyethylene terephthalate) was immersed in the unused decolorizing solution placed in a pressurized reaction chamber, followed by conducting a first decolorizing treatment, which was performed at 130° C. for 30 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

In step (b), the first dried decolorized polyester fabric obtained in step (a) was immersed in the first used decolorizing solution (serving as a second decolorizing solution), which was obtained in step (a) and was placed in a pressurized reaction chamber, followed by conducting a second decolorizing treatment, which was performed at 100° C. for 30 minutes under a controlled pressure to avoid the leakage of water vapor or gas explosion from the pressurized reaction chamber, so as to obtain a second decolorized polyester fabric and a second used decolorizing solution. Thereafter, the second decolorized polyester fabric was taken out from the second used decolorizing solution, and the second used decolorizing solution remaining on the second decolorized polyester fabric was washed off with water at 25° C., so as to obtain a washed decolorized polyester fabric. The washed decolorized polyester fabric was subjected to a dehydration treatment and a shade drying treatment in sequence so as to obtain a second dried decolorized polyester fabric.

In step (c), the second used decolorizing solution obtained in step (b) was subjected to a distillation treatment at 98° C. so as to obtain a transparent and colorless distillate containing water and cyclohexanone. In the distillate, the weight ratio of water to cyclohexanone was 6:4. Next, 125 mL of the distillate and 0.1575 g of sodium hydroxide were mixed to obtain a decolorized solution containing 75 g of water, 0.1575 g of sodium hydroxide, and 50 mL of cyclohexanone. In the decolorized solution, the amount of sodium hydroxide was 2.1 g, and the amount of cyclohexanone was 666.67 mL, based on 1 L of water.

The second dried decolorized polyester fabric obtained in step (b) was immersed in the decolorized solution (serving as a third decolorizing solution) placed in a pressurized reaction chamber, followed by conducting a third decolorizing treatment, which was performed at 100° C. for 30 minutes under a controlled pressure to avoid the leakage of water vapor or gas explosion from the pressurized reaction chamber, so as to obtain a third decolorized polyester fabric and a third used decolorizing solution. Thereafter, the third decolorized polyester fabric was taken out from the third used decolorizing solution, and the third used decolorizing solution remaining on the third decolorized polyester fabric was washed off with water at 25° C., so as to obtain a washed decolorized polyester fabric. The washed decolorized polyester fabric was subjected to a dehydration treatment and a shade drying treatment in sequence so as to obtain a third dried decolorized polyester fabric.

### Example 40 (EX40)

The first to the third dried decolorized polyester fabrics of EX40 were prepared as follows.

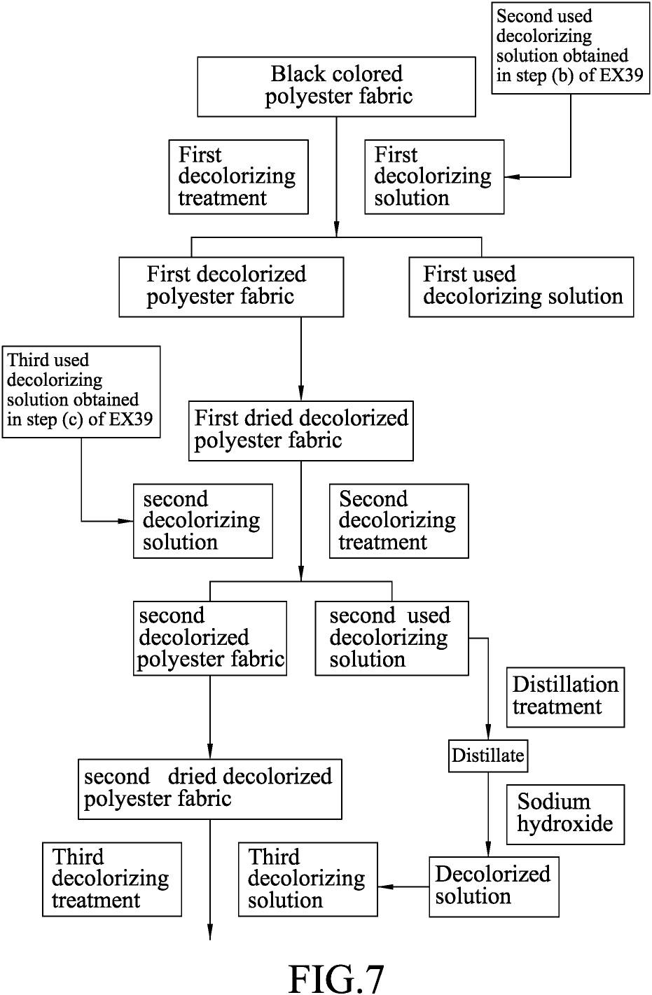

Referring to FIG. 7, in step (a), 5 g of a black colored polyester fabric (the weight ratio of water to the black colored polyester fabric was 15.4:1, i.e., 75.1925 g:5 g, and the polyester was polyethylene terephthalate) was immersed in the second used decolorizing solution (serving as a first decolorizing solution), which was obtained in step (b) of EX39 and was placed in a pressurized reaction chamber, followed by conducting a first decolorizing treatment, which was performed at 130° C. for 30 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

In step (b), 5 g of the first dried decolorized polyester fabric obtained in step (a) was immersed in the third used decolorizing solution (serving as a second decolorizing solution), which was obtained in step (c) of EX39 and was placed in a pressurized reaction chamber, followed by conducting a second decolorizing treatment, which was performed at 100° C. for 30 minutes under a controlled pressure to avoid the leakage of water vapor or gas explosion from the pressurized reaction chamber, so as to obtain a second decolorized polyester fabric and a second used decolorizing solution. Thereafter, the second decolorized polyester fabric was taken out from the second used decolorizing solution, and the second used decolorizing solution remaining on the second decolorized polyester fabric was washed off with water at 25° C., so as to obtain a washed decolorized polyester fabric. The washed decolorized polyester fabric was subjected to a dehydration treatment and a shade drying treatment in sequence so as to obtain a second dried decolorized polyester fabric.

In step (c), the second used decolorizing solution obtained in step (b) was subjected to a distillation treatment at 98° C. so as to obtain a transparent and colorless distillate containing water and cyclohexanone. In the distillate, the weight ratio of water to cyclohexanone was 6:4. Next, 125 mL of the distillate and 0.1575 g of sodium hydroxide were mixed to obtain a decolorized solution containing 75 g of water, 0.1575 g of sodium hydroxide, and 50 mL of cyclohexanone. In the decolorized solution, the amount of sodium hydroxide was 2.1 g, and the amount of cyclohexanone was 666.67 mL, based on 1 L of water.

The second dried decolorized polyester fabric obtained in step (b) was immersed in the decolorized solution (serving as a third decolorizing solution) placed in a pressurized reaction chamber, followed by conducting a third decolorizing treatment, which was performed at 100° C. for 30 minutes under a controlled pressure to avoid the leakage of water vapor or gas explosion from the pressurized reaction chamber, so as to obtain a third decolorized polyester fabric and a third used decolorizing solution. Thereafter, the third decolorized polyester fabric was taken out from the third used decolorizing solution, and the third used decolorizing solution remaining on the third decolorized polyester fabric was washed off with water at 25° C., so as to obtain a washed decolorized polyester fabric. The washed decolorized polyester fabric was subjected to a dehydration treatment and a shade drying treatment in sequence so as to obtain a third dried decolorized polyester fabric.

### Example 41 (EX41)

75.4125 g of water, 0.3375 g of sodium hydroxide, 20 mL of butanone, and 10 mL of cyclohexanone were mixed to obtain an unused decolorizing solution (serving as a first decolorizing solution). The amount of sodium hydroxide was 4.48 g (i.e., (0.3375×1000)/75.4125), and the total amount of butanone and cyclohexanone was 397.81 mL (i.e., (30×1000)/75.4125), based on 1 L of water.

Next, 5 g of a black colored polyester fabric (the weight ratio of water to the black colored polyester fabric was 15.08:1, i.e., 75.4125 g:5 g, and the polyester was polyethylene terephthalate) was immersed in the unused decolorizing solution placed in a pressurized reaction chamber, followed by conducting a first decolorizing treatment, which was performed at 100° C. for 60 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

### Examples 42 to 45 (EX42 to EX45)

The procedures for preparing the first dried decolorized polyester fabrics of EX42 to EX45 were similar to those of EX41, except that the types and amounts of the ketone solvent used for making the unused decolorizing solution were varied as shown in Tables 1 and 2 below.

### Example 46 (EX46)

75.4125 g of water, 0.3375 g of sodium hydroxide, and 30 mL of cyclohexanone were mixed to obtain an unused decolorizing solution (serving as a first decolorizing solution). The amount of sodium hydroxide was 4.48 g (i.e., (0.3375×1000)/75.4125), and the amount of cyclohexanone was 397.81 mL (i.e., (30×1000)/75.4125), based on 1 L of water.

Next, 5 g of a black colored polyester fabric (the weight ratio of water to the black colored polyester fabric was 15.08:1, i.e., 75.4125 g:5 g, and the polyester was polybutylene terephthalate) (Cat. No. 50D/24F, Far Eastern New Century Corporation) was immersed in the unused decolorizing solution placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

### Example 47 (EX47)

75.4125 g of water, 0.3375 g of sodium hydroxide, and 30 mL of cyclohexanone were mixed to obtain an unused decolorizing solution (serving as a first decolorizing solution). The amount of sodium hydroxide was 4.48 g (i.e., (0.3375×1000)/75.4125), and the amount of cyclohexanone was 397.81 mL (i.e., (30×1000)/75.4125), based on 1 L of water.

Next, 5 g of a black colored polyester fabric (the weight ratio of water to the black colored polyester fabric was 15.08:1, i.e., 75.4125 g:5 g, and the polyester was a mixture of polyethylene terephthalate and polypropylene terephthalate) (Cat. No. T400, Invista) was immersed in the unused decolorizing solution placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized polyester fabric and a first used decolorizing solution. Thereafter, the first decolorized polyester fabric was taken out from the first used decolorizing solution, and the first used decolorizing solution remaining on the first decolorized polyester fabric was washed off with water at 25° C., so as to obtain a washed decolorized polyester fabric. The washed decolorized polyester fabric was subjected to a dehydration treatment and a shade drying treatment in sequence so as to obtain a first dried decolorized polyester fabric.

### Example 48 (EX48)

75.4125 g of water, 0.3375 g of sodium hydroxide, and 30 mL of cyclohexanone were mixed to obtain an unused decolorizing solution (serving as a first decolorizing solution). The amount of sodium hydroxide was 4.48 g (i.e., (0.3375×1000)/75.4125), and the amount of cyclohexanone was 397.81 mL (i.e., (30×1000)/75.4125), based on 1 L of water.

Next, 5 g of a black colored nylon fabric (the weight ratio of water to the black colored nylon fabric was 15.08:1, i.e., 75.4125 g:5 g) (Cat. No. 250D-Nylon6, Fabric Republic) was immersed in the unused decolorizing solution placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized nylon fabric and a first used decolorizing solution. Thereafter, the first decolorized nylon fabric was taken out from the first used decolorizing solution, and the first used decolorizing solution remaining on the first decolorized nylon fabric was washed off with water at 25° C., so as to obtain a washed decolorized nylon fabric. The washed decolorized nylon fabric was subjected to a dehydration treatment and a shade drying treatment in sequence so as to obtain a first dried decolorized nylon fabric.

### Example 49 (EX49)

75.4125 g of water, 0.3375 g of sodium hydroxide, and 30 mL of cyclohexanone were mixed to obtain an unused decolorizing solution (serving as a first decolorizing solution). The amount of sodium hydroxide was 4.48 g (i.e., (0.3375×1000)/75.4125), and the amount of cyclohexanone was 397.81 mL (i.e., (30×1000)/75.4125), based on 1 L of water.

Next, 5 g of a black colored cotton fabric (the weight ratio of water to the black colored cotton fabric was 15.08:1, i.e., 75.4125 g:5 g, and the cotton fabric was a 6N cotton canvas purchased from Fabric Republic) was immersed in the unused decolorizing solution placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized cotton fabric and a first used decolorizing solution. Thereafter, the first decolorized cotton fabric was taken out from the first used decolorizing solution, and the first used decolorizing solution remaining on the first decolorized cotton fabric was washed off with water at 25° C., so as to obtain a washed decolorized cotton fabric. The washed decolorized cotton fabric was subjected to a dehydration treatment and a shade drying treatment in sequence so as to obtain a first dried decolorized cotton fabric.

### Example 50 (EX50)

75.4125 g of water, 0.3375 g of sodium hydroxide, and 30 mL of cyclohexanone were mixed to obtain an unused decolorizing solution (serving as a first decolorizing solution). The amount of sodium hydroxide was 4.48 g (i.e., (0.3375×1000)/75.4125), and the amount of cyclohexanone was 397.81 mL (i.e., (30×1000)/75.4125), based on 1 L of water.

Next, 5 g of a blue colored linen fabric (the weight ratio of water to the blue colored linen fabric was 15.08:1, i.e., 75.4125 g:5 g, and the linen fabric was a dark blue fine linen woven fabric with a thickness of 0.8 mm and was purchased from Fabric Republic) was immersed in the unused decolorizing solution placed in a pressurized reaction chamber, followed by conducting a first decolorizing treatment, which was performed at 130° C. for 60 minutes under a controlled pressure to avoid the leakage of water vapor or gas explosion from the pressurized reaction chamber, so as to obtain a first decolorized linen fabric and a first used decolorizing solution. Thereafter, the first decolorized linen fabric was taken out from the first used decolorizing solution, and the first used decolorizing solution remaining on the first decolorized linen fabric was washed off with water at 25° C., so as to obtain a washed decolorized linen fabric. The washed decolorized linen fabric was subjected to a dehydration treatment and a shade drying treatment in sequence so as to obtain a first dried decolorized linen fabric.

### Example 51 (EX51)

75.4125 g of water, 0.3375 g of sodium hydroxide, and 30 mL of cyclohexanone were mixed to obtain an unused decolorizing solution (serving as a first decolorizing solution). The amount of sodium hydroxide was 4.48 g (i.e., (0.3375×1000)/75.4125), and the amount of cyclohexanone was 397.81 mL (i.e., (30×1000)/75.4125), based on 1 L of water.

Next, 5 g of a green colored polyester flake (the weight ratio of water to the green colored polyester flake was 15.08:1, i.e., 75.4125 g:5 g, the green colored polyester flake was obtained by pulverizing a commercially available green colored polyester bottle for filling soft drink “Sprite” with a pulverizer purchased from Pentad Scientific Corporation, and the polyester was polyethylene terephthalate) was immersed in the unused decolorizing solution placed in a pressurized reaction chamber, followed by conducting a first decolorizing treatment, which was performed at 130° C. for 180 minutes under a controlled pressure to avoid the leakage of water vapor or gas explosion from the pressurized reaction chamber, so as to obtain a first decolorized polyester flake and a first used decolorizing solution. Thereafter, the first decolorized polyester flake was taken out from the first used decolorizing solution, and the first used decolorizing solution remaining on the first decolorized polyester flake was washed off with water at 25° C., so as to obtain a washed decolorized polyester flake. The washed decolorized polyester flake was subjected to a dehydration treatment and a shade drying treatment in sequence so as to obtain a first dried decolorized polyester flake.

### Comparative Example 1 (CE1)

A black colored polyester fabric (the polyester was polyethylene terephthalate) without any decolorizing treatment was used as the test sample of CE1.

### Comparative Examples 2 to 17 (CE2 to CE17)

The procedures for preparing the first dried decolorized polyester fabrics of CE2 to CE17 were similar to those of EX1, except for the components and the amounts thereof for making the first decolorizing solution, and the operation conditions for the first decolorizing treatment were varied as shown in Tables 3 and 4 below. In addition, sodium hydroxymethanesulfinate (SFS) was used as a reducing agent for making the first decolorizing solutions of CE3 to CE6, and sodium dithionite (Na₂S₂O₄) was used as a reducing agent for making the first decolorizing solutions of CE7, CE8, CE16, and CE17.

### Comparative Example 18 (CE18)

The procedures for preparing the first dried decolorized polyester fabric of CE18 were similar to those of EX36, except that the amount of sodium hydroxide used for making the first decolorizing solution was 0.1013 g, and sodium dithionite (Na₂S₂O₄) was used as a reducing agent, as shown in Tables 3 and 4 below. The amount of sodium hydroxide was 1.34 g (i.e., (0.1013×1000)/75.4125), the amount of cyclohexanone was 397.81 mL (i.e., (30×1000)/75.4125), and the amount of sodium dithionite was 2.98 g (i.e., (0.225×1000)/75.4125), based on 1 L of water.

### Comparative Examples 19 to 24 (CE19 to CE24)

A black colored polyester fabric (the polyester was polybutylene terephthalate) without any decolorizing treatment was used as the test sample of CE19. A black colored polyester fabric (the polyester was a mixture of polyethylene terephthalate and polypropylene terephthalate) without any decolorizing treatment was used as the test sample of CE20. A black colored nylon fabric without any decolorizing treatment was used as the test sample of CE21. A black colored cotton fabric without any decolorizing treatment was used as the test sample of CE22. A blue colored linen fabric without any decolorizing treatment was used as the test sample of CE23. A green colored polyester flake without any decolorizing treatment as described above was used as the test sample of CE24.

The decolorizing solutions and the operation conditions of the decolorizing treatment for EX1 to EX51 and CE1 to CE18 are summarized in Tables 1 to 4 below.

TABLE 1

| EX | Decolorizing solution | | | | | |
|---|---|---|---|---|---|---|
| | Water | Treating agent | | Ketone solvent | | pH value |
| | Amount (g) | Type | Amount (g) | Type | Amount (mL) | |
| 1 | 75.4125 | NaOH | 0.3375 | Butanone | 30 | 13 |
| 2 | 75.4125 | NaOH | 0.3375 | Butanone | 30 | 13 |
| 3 | 75.4125 | NaOH | 0.3375 | Butanone | 30 | 13 |
| 4 | 75.4125 | NaOH | 0.3375 | Butanone | 15 | 13 |
| 5 | 50.4125 | NaOH | 0.3375 | Butanone | 30 | 13 |
| 6 | 50.4125 | NaOH | 0.3375 | Butanone | 15 | 14 |
| 7 | 75.4125 | NaOH | 0.3375 | Cyclohexanone | 30 | 14 |
| 8 | 75.4125 | NaOH | 0.3375 | Cyclohexanone | 30 | 14 |
| 9 | 75.4125 | NaOH | 0.3375 | Cyclohexanone | 30 | 14 |
| 10 | 75.4125 | NaOH | 0.3375 | Cyclohexanone | 45 | 14 |
| 11 | 75.4125 | NaOH | 0.3375 | Cyclohexanone | 15 | 14 |
| 12 | 75.4125 | NaOH | 0.3375 | Cyclohexanone | 7.5 | 14 |
| 13 | 75.4125 | NaOH | 0.3375 | Cyclohexanone | 30 | 14 |
| 14 | 75.4125 | NaOH | 0.3375 | Cyclohexanone | 30 | 14 |
| 15 | 75.4125 | NaOH | 0.3375 | Cyclohexanone | 30 | 14 |
| 16 | 75.4125 | NaOH | 0.3375 | Cyclohexanone | 15 | 14 |
| 17 | 75.4125 | NaOH | 0.3375 | Cyclohexanone | 7.5 | 14 |
| 18 | 75.4125 | NaOH | 0.3375 | Cyclohexanone | 3.75 | 14 |
| 19 | 50.4125 | NaOH | 0.3375 | Cyclohexanone | 30 | 14 |
| 20 | 50.4125 | NaOH | 0.3375 | Cyclohexanone | 20 | 14 |
| 21 | 50.4125 | NaOH | 0.3375 | Cyclohexanone | 10 | 14 |
| 22 | 50.4125 | NaOH | 0.3375 | Cyclohexanone | 5 | 14 |
| 23 | 50.4125 | NaOH | 0.3375 | Cyclohexanone | 30 | 14 |
| 24 | 50.4125 | NaOH | 0.3375 | Cyclohexanone | 15 | 14 |
| 25 | 50.4125 | NaOH | 0.3375 | Cyclohexanone | 7.5 | 14 |
| 26 | 50.4125 | NaOH | 0.3375 | Cyclohexanone | 3.75 | 14 |
| 27 | 25.1375 | NaOH | 0.1125 | Cyclohexanone | 15 | 14 |
| 28 | 25.1375 | NaOH | 0.1125 | Cyclohexanone | 10 | 14 |
| 29 | 25.1375 | NaOH | 0.1125 | Cyclohexanone | 5 | 14 |
| 30 | 25.1375 | NaOH | 0.1125 | Cyclohexanone | 2.5 | 14 |
| 31 | 25.1375 | NaOH | 0.1125 | Cyclohexanone | 1.25 | 14 |
| 32 | 75.4125 | NaOH | 0.3375 | Acetone | 75 | 13 |
| 33 | 75.4125 | NaOH | 0.3375 | Cyclohexanone | 30 | 14 |
| | | Na₂S₂O₄ | 0.225 | | | |
| 34 | 75.4125 | NaOH | 0.3375 | Butanone | 30 | 13 |
| | 75.4125 | NaOH | 0.3375 | Butanone | 30 | 13 |
| 35 | 75.4125 | NaOH | 0.3375 | Cyclohexanone | 30 | 14 |
| | 75.4125 | NaOH | 0.3375 | Cyclohexanone | 30 | 14 |
| 36 | 75 | NaOH | 0.3375 | Cyclohexanone | 50 | 14 |
| | 75 | NaOH | 0.3375 | Cyclohexanone | 50 | 14 |
| | 75 | NaOH | 0.3375 | Cyclohexanone | 50 | 14 |
| 37 | 75 | NaOH | 0.1576 | Cyclohexanone | 50 | 13 |
| | 75 | NaOH | 0.1576 | Cyclohexanone | 50 | 13 |
| | 75 | NaOH | 0.1576 | Cyclohexanone | 50 | 13 |
| 38 | 75.4125 | NaOH | 0.3375 | Cyclohexanone | 50 | 14 |
| 39 | 75.1925 | NaOH | 0.1575 | Cyclohexanone | 50 | 13 |
| | 75.1925 | NaOH | 0.1575 | Cyclohexanone | 50 | 13 |
| | 75 | NaOH | 0.1575 | Cyclohexanone | 50 | 13 |
| 40 | 75.1925 | NaOH | 0.1575 | Cyclohexanone | 50 | 13 |
| | 75 | NaOH | 0.1575 | Cyclohexanone | 50 | 13 |
| | 75 | NaOH | 0.1575 | Cyclohexanone | 50 | 13 |
| 41 | 75.4125 | NaOH | 0.3375 | Butanone | 20 | 14 |
| | | | | Cyclohexanone | 10 | |
| 42 | 75.4125 | NaOH | 0.3375 | Butanone | 15 | 14 |
| | | | | Cyclohexanone | 15 | |
| 43 | 75.4125 | NaOH | 0.3375 | Butanone | 10 | 14 |
| | | | | Cyclohexanone | 20 | |
| 44 | 75.4125 | NaOH | 0.3375 | Butanone | 15 | 14 |
| | | | | Acetone | 15 | |
| 45 | 75.4125 | NaOH | 0.3375 | Acetone | 15 | 14 |
| | | | | Cyclohexanone | 15 | |
| 46 | 75.4125 | NaOH | 0.3375 | Cyclohexanone | 30 | 14 |
| 47 | 75.4125 | NaOH | 0.3375 | Cyclohexanone | 30 | 14 |
| 48 | 75.4125 | NaOH | 0.3375 | Cyclohexanone | 30 | 14 |
| 49 | 75.4125 | NaOH | 0.3375 | Cyclohexanone | 30 | 14 |
| 50 | 75.4125 | NaOH | 0.3375 | Cyclohexanone | 30 | 14 |
| 51 | 75.4125 | NaOH | 0.3375 | Cyclohexanone | 30 | 14 |

TABLE 2

| EX | Decolorizing treatment | | Base (g)/water (L) | Ketone (mL) /water (L) |
|---|---|---|---|---|
| | Temperature (°C) | Time (minute) | | |
| 1 | 100 | 90 | 4.48 | 397.81 |
| 2 | 100 | 60 | | |
| 3 | 100 | 30 | | |
| 4 | 100 | 60 | | 198.91 |
| 5 | 100 | 60 | 6.69 | 595.09 |
| 6 | 100 | 60 | | 297.55 |
| 7 | 100 | 90 | 4.48 | 397.81 |
| 8 | 100 | 60 | | |
| 9 | 100 | 30 | | |
| 10 | 100 | 60 | | 596.72 |
| 11 | 100 | 60 | | 198.91 |
| 12 | 100 | 60 | | 99.45 |
| 13 | 130 | 90 | | 397.81 |
| 14 | 130 | 60 | | |
| 15 | 130 | 30 | | |
| 16 | 130 | 60 | | 198.91 |
| 17 | 130 | 60 | | 99.45 |
| 18 | 130 | 60 | | 49.73 |
| 19 | 100 | 60 | 6.69 | 595.09 |
| 20 | 100 | 60 | | 396.73 |
| 21 | 100 | 60 | | 198.36 |
| 22 | 100 | 60 | | 99.18 |
| 23 | 130 | 60 | | 595.09 |
| 24 | 130 | 60 | | 297.55 |
| 25 | 130 | 60 | | 148.77 |
| 26 | 130 | 60 | | 74.39 |
| 27 | 100 | 60 | 4.48 | 596.72 |
| 28 | 100 | 60 | | 397.81 |
| 29 | 100 | 60 | | 198.91 |
| 30 | 130 | 60 | | 99.45 |
| 31 | 130 | 60 | | 49.73 |
| 32 | 100 | 60 | | 994.53 |
| 33 | 130 | 60 | | 397.81 |
| 34 | 100 | 60 | | |
| | 100 | 60 | | |
| 35 | 130 | 60 | | |
| | 130 | 60 | | |
| 36 | 130 | 60 | 4.5 | 666.67 |
| | 130 | 60 | | |
| | 130 | 60 | | |
| 37 | 130 | 60 | 2.10 | 666.67 |
| | 130 | 60 | | |
| | 130 | 60 | | |
| 38 | 130 | 60 | 4.48 | 663.02 |
| 39 | 130 | 30 | 2.09 | 664.96 |
| | 100 | 30 | 2.09 | 664.96 |
| | 100 | 30 | 2.1 | 666.67 |
| 40 | 130 | 30 | 2.09 | 664.96 |
| | 100 | 30 | 2.1 | 666.67 |
| | 100 | 30 | 2.1 | 666.67 |
| 41 | 100 | 60 | 4.48 | 397.81 |
| 42 | 100 | 60 | 4.48 | 397.81 |
| 43 | 100 | 60 | 4.48 | 397.81 |
| 44 | 100 | 60 | 4.48 | 397.81 |
| 45 | 100 | 60 | 4.48 | 397.81 |
| 46 | 130 | 60 | 4.48 | 397.81 |
| 47 | 130 | 60 | 4.48 | 397.81 |
| 48 | 130 | 60 | 4.48 | 397.81 |
| 49 | 130 | 60 | 4.48 | 397.81 |
| 50 | 130 | 60 | 4.48 | 397.81 |
| 51 | 130 | 180 | 4.48 | 397.81 |

TABLE 3

| CE | Decolorizing solution | | | | | |
|---|---|---|---|---|---|---|
| | Water | Treating agent | | Ketone solvent | | pH value |
| | Amount (g) | Type | Amount (g) | Type | Amount (mL) | |
| 1 | - | - | - | - | - | - |
| 2 | 75.4125 | NaOH | 0.3375 | - | 0 | 14 |
| 3 | 75 | SFS | 0.12 | - | 0 | 6 |
| 4 | 75 | SFS | 0.12 | Acetone | 75 | 6 |
| 5 | 75 | SFS | 0.75 | Acetone | 75 | 6 |
| 6 | 250 | SFS | 10 | Acetone | 250 | 5 |
| 7 | 75 | Na₂S₂O₄ | 0.225 | Acetone | 75 | 6 |
| 8 | 75 | Na₂S₂O₄ | 0.75 | Acetone | 75 | 5 |
| 9 | 75.4125 | NaOH | 0.3375 | Ethanol | 30 | 13 |
| 10 | 75.4125 | NaOH | 0.3375 | Ethylene Glycol | 30 | 13 |
| 11 | 75.4125 | NaOH | 0.3375 | n-butanol | 30 | 13 |
| 12 | 75 | - | 0 | Acetone | 75 | 7 |
| 13 | 75 | - | 0 | Acetone | 75 | 7 |
| 14 | 75.4125 | NaOH | 0.3375 | - | 0 | 14 |
| 15 | 75.4125 | NaOH | 0.3375 | Acetone | 75 | 13 |
| 16 | 75.1238 | NaOH | 0.1013 | - | 0 | 13 |
| | | Na₂S₂O₄ | 0.225 | | | |
| 17 | 75.4125 | NaOH | 0.3375 | - | 0 | 14 |
| | | Na₂S₂O₄ | 0.225 | | | |
| 18 | 75.4125 | NaOH | 0.1013 | Cyclohexanone | 30 | 13 |
| | | Na₂S₂O₄ | 0.225 | | | |

TABLE 4

| CE | Decolorizing treatment | | Base (g)/water (L) | Ketone (mL)/water (L) |
|---|---|---|---|---|
| | Temperature (°C) | Time (minute) | | |
| 1 | - | - | - | - |
| 2 | 130 | 60 | 4.48 | - |
| 3 | 100 | 60 | - | - |
| 4 | 100 | 60 | - | 1000 |
| 5 | 100 | 60 | - | 1000 |
| 6 | 100 | 60 | - | 1000 |
| 7 | 100 | 60 | - | 1000 |
| 8 | 100 | 60 | - | 1000 |
| 9 | 100 | 60 | 4.48 | - |
| 10 | 130 | 60 | 4.48 | - |
| 11 | 130 | 60 | 4.48 | - |
| 12 | 100 | 60 | - | 1000 |
| 13 | 70 | 60 | - | 1000 |
| 14 | 70 | 60 | 4.48 | - |
| 15 | 70 | 60 | 4.48 | 994.53 |
| 16 | 130 | 60 | 1.35 | - |
| 17 | 130 | 60 | 4.48 | - |
| 18 | 130 | 60 | 1.34 | 397.81 |

### Property Evaluation

The first dried decolorized polyester fabric of the EX 1 to EX 33, EX38, and EX41 to EX 47, the first and second dried decolorized polyester fabrics of EX34 to EX35, the first to the third dried decolorized polyester fabrics of EX36 to EX37 and EX39 to EX40, the first dried decolorized nylon fabric of EX48, the first dried decolorized cotton fabric of EX49, the first dried decolorized linen fabric of EX50, and the first dried decolorized polyester flake of EX51 were respectively used as test samples, and were subjected to the following analyses.

### A. Measurement of Chromaticity

The CIE L*a*b* values of the respective test sample were measured using a spectrophotometer (Datacolor 850). The chromaticity of the respective one of the test samples of EX1 to EX45 and CE2 to CE18 was calculated by comparing the measured CIE L*a*b* values to those measured for the test sample of CE1 (i.e., the CIE L*a*b* values measured for CE1 were defined as 100). CE1 had the CIE L*a*b* values of L*: 14.58, a*: 0.40, and b*: -1.93. The lower the value of the chromaticity, the better the decolorization effect is.

Moreover, the chromaticity of EX46 was calculated by comparing the measured CIE L*a*b* values to those measured for CE19 (i.e., the CIE L*a*b* values measured for CE19 were defined as 100). CE19 had the CIE L*a*b* values of L*: 14.68, a*: 0.31, and b*: -0.87. The chromaticity of EX47 was calculated by comparing the measured CIE L*a*b* values to those measured for CE20 (i.e., the CIE L*a*b* values measured for CE20 were defined as 100). CE20 had the CIE L*a*b* values of L*: 13.21, a*: 0.10, and b*: -1.57. The chromaticity of EX48 was calculated by comparing the measured CIE L*a*b* values to those measured for CE21 (i.e., the CIE L*a*b* values measured for CE21 were defined as 100). CE21 had the CIE L*a*b* values of L*: 22.55, a*: -0.16, and b*: -3.13. The chromaticity of EX49 was calculated by comparing the measured CIE L*a*b* values to those measured for CE22 (i.e., the CIE L*a*b* values measured for CE22 were defined as 100). CE22 had the CIE L*a*b* values of L*: 19.80, a*: -0.26, and b*: -2.09. The chromaticity of EX50 was calculated by comparing the measured CIE L*a*b* values to those measured for CE23 (i.e., the CIE L*a*b* values measured for CE23 were defined as 100). CE23 had the CIE L*a*b* values of L*: 27.41, a*: -1.30, and b*: -14.21. The chromaticity of EX51 was calculated by comparing the measured CIE L*a*b* values to those measured for CE24 (i.e., the CIE L*a*b* values measured for CE24 were defined as 100). CE24 had the CIE L*a*b* values of L*: 71.65, a*: -40.40, and b*: 31.37. The results are shown in Tables 5 to 6 below.

### B. Measurement of Decolorization Rate

The decolorization rate of the respective one of the test samples of EX1 to EX51 was calculated using the following Equation (I):

$$\text{A=} \left[\left(\text{B} - \text{C}\right) / \text{B}\right] \times 100 \%$$

where A=decolorization rate (%)

B=chromaticity of CE1, CE19, CE20, CE21, CE22, CE23, or CE24

C=chromaticity of the respective EX

In particular, the chromaticity of CE1 was used to calculate the decolorization rate of EX1 to EX45, and the chromaticity of CE19 to CE24 was used to calculate the decolorization rate of EX46 to EX51, respectively.

Moreover, the decolorization rate of the respective one of the test samples of CE2 to CE18 was calculated using the following Equation (II):

$$\text{A=} \left[\left({\text{B}}^{′} - {\text{C}}^{′}\right) / {\text{B}}^{′}\right] \times 100 \%$$

where A=decolorization rate (%)

B′=chromaticity of CE1

C′=chromaticity of the respective one of CE2 to CE18

The results are shown in Tables 5 to 6 below.

TABLE 5

| EX | Decolorizing treatment | Decolorizing solution | Chromaticity | Decolorization rate |
|---|---|---|---|---|
| 1 | First decolorizing treatment | Unused decolorizing solution | 2.1 | 97.9 |
| 2 | | | 3.1 | 96.9 |
| 3 | | | 8.0 | 92.0 |
| 4 | | | 8.8 | 91.2 |
| 5 | | | 4.0 | 96.0 |
| 6 | | | 11.8 | 88.2 |
| 7 | | | 2.6 | 97.4 |
| 8 | | | 4.4 | 95.6 |
| 9 | | | 10.8 | 89.2 |
| 10 | | | 3.8 | 96.2 |
| 11 | | | 4.3 | 95.7 |
| 12 | | | 4.7 | 95.3 |
| 13 | | | 3.1 | 96.9 |
| 14 | | | 4.4 | 95.6 |
| 15 | | | 6.9 | 93.1 |
| 16 | | | 4.4 | 95.6 |
| 17 | | | 5.1 | 94.9 |
| 18 | | | 5.6 | 94.4 |
| 19 | | | 4.0 | 96.0 |
| 20 | | | 4.0 | 96.0 |
| 21 | | | 4.4 | 95.6 |
| 22 | | | 5.1 | 94.9 |
| 23 | | | 3.4 | 96.6 |
| 24 | | | 3.7 | 96.3 |
| 25 | | | 6.1 | 93.9 |
| 26 | | | 6.8 | 93.2 |
| 27 | | | 6.3 | 93.7 |
| 28 | | | 7.1 | 92.9 |
| 29 | | | 9.4 | 90.6 |
| 30 | | | 6.9 | 93.1 |
| 31 | | | 7.2 | 92.8 |
| 32 | | | 7.6 | 92.4 |
| 33 | | | 2.3 | 97.7 |
| 34 | First decolorizing treatment | Unused decolorizing solution | 3.3 | 96.7 |
| | Second decolorizing treatment | Unused decolorizing solution | 1.2 | 98.8 |
| 35 | First decolorizing treatment | Unused decolorizing solution | 3.5 | 96.5 |
| | Second decolorizing treatment | Unused decolorizing solution | 0.6 | 99.4 |
| 36 | First decolorizing treatment | Unused decolorizing solution | 3.8 | 96.2 |
| | Second decolorizing treatment | Decolorized solution | 3.44 | 96.56 |
| | Third decolorizing treatment | Decolorized solution | 3.13 | 96.87 |
| 37 | First decolorizing treatment | Unused decolorizing solution | 6.95 | 93.05 |
| | Second decolorizing treatment | Decolorized solution | 6.8 | 93.2 |
| | Third decolorizing treatment | Decolorized solution | 6.52 | 93.48 |
| 38 | First decolorizing treatment | Decolorized solution | 5.8 | 94.2 |
| 39 | First decolorizing treatment | Unused decolorizing solution | 2.4 | 97.6 |
| | Second decolorizing treatment | First used decolorizing solution | 0.36 | 99.64 |
| | Third decolorizing treatment | Decolorized solution | 0.15 | 99.85 |
| 40 | First decolorizing treatment | Second used decolorizing solution | 7.73 | 92.27 |
| | Second decolorizing treatment | Third used decolorizing solution | 0.31 | 99.69 |
| | Third decolorizing treatment | Decolorized solution | 0.26 | 99.74 |
| 41 | First decolorizing treatment | Unused decolorizing solution | 3.9 | 96.1 |
| 42 | | | 4.1 | 95.9 |
| 43 | | | 4.0 | 96.0 |
| 44 | | | 7.1 | 92.9 |
| 45 | | | 4.3 | 95.7 |
| 46 | | | 3.7 | 96.3 |
| 47 | | | 3.1 | 96.9 |
| 48 | | | 7.2 | 92.8 |
| 49 | | | 6.2 | 93.8 |
| 50 | | | 2.5 | 97.5 |
| 51 | | | 7.8 | 92.2 |

TABLE 6

| CE | Decolorizing treatment | Decolorizing solution | Chromaticity | Decolorization rate |
|---|---|---|---|---|
| 1 | Without any decolorizing treatment | - | 100 | - |
| 2 | First decolorizing treatment | - | 28.1 | 71.9 |
| 3 | | - | 102.2 | -2.2 |
| 4 | | - | 18.6 | 81.4 |
| 5 | | - | 14.8 | 85.2 |
| 6 | | - | 7.3 | 92.7 |
| 7 | | - | 15.5 | 84.5 |
| 8 | | - | 12.3 | 87.7 |
| 9 | | - | 91.2 | 8.8 |
| 10 | | - | 33.5 | 66.5 |
| 11 | | - | 31.7 | 68.3 |
| 12 | | - | 24.0 | 76.0 |
| 13 | Without any decolorizing treatment | - | 93.7 | 6.3 |
| 14 | | - | 90.3 | 9.7 |
| 15 | | - | 79.2 | 20.8 |
| 16 | | - | 43.5 | 56.5 |
| 17 | | - | 31.3 | 68.7 |
| 18 | | - | 20.0 | 80.0 |
| 19 | | - | 100 | - |
| 20 | | - | 100 | - |
| 21 | | - | 100 | - |
| 22 | | - | 100 | - |
| 23 | | - | 100 | - |
| 24 | | - | 100 | - |

### Results

It can be seen from Tables 1 to 6 that a respective one of the test samples (i.e., the decolorized polyester fabrics) of EX1 to EX45, which was obtained by subjecting a black colored polyester fabric to a decolorizing treatment with a decolorizing solution containing water, a ketone solvent, and a base, or additionally added sodium dithionite at a temperature ranging from 100° C. to 130° C. for a time period ranging from 30 minutes to 90 minutes, had a low chromaticity and a high decolorization rate. These results indicate that the method for decolorizing a colored polymer material of the present disclosure has excellent decolorization effect.

In the preparation procedures for EX38, the black colored polyester fabric was subjected to the first decolorizing treatment with the decolorized solution (which was obtained by subjecting the used decolorizing solution to a distillation treatment, followed by mixing with a component containing a base), and the first dried decolorized polyester fabric thus obtained had a decolorization rate of 94.2%. These results indicate that the recovered decolorizing solution not only exerts excellent decolorization effect, but also reduces the cost of waste treatment and environmental pollution.

In the preparation procedures for EX39, the black colored polyester fabric was subjected to the first to third decolorizing treatments. The first decolorizing treatment was conducted using the unused decolorizing solution, the second decolorizing treatment was conducted using the first used decolorizing solution obtained after the first decolorizing treatment, and the third decolorizing treatment was conducted using the decolorized solution which was obtained by subjecting the second used decolorizing solution obtained after the second decolorizing treatment to a distillation treatment, followed by mixing with a base. The decolorization rates of the first to third decolorizing treatments were 97.6%, 99.64%, and 99.85%, respectively. These results indicate that regardless of using the used decolorizing solution or the decolorized solution as a decolorizing solution, the black dye in the black colored polyester fabric can be almost entirely removed, and an excellent decolorization effect can be achieved. In addition, the chromaticities of the decolorized polyester fabrics obtained from the first to third decolorizing treatments were 2.4, 0.36, and 0.15, respectively. These results indicate that the use of the used decolorizing solution can persistently reduce the chromaticity of the decolorized polyester fabrics, and will not cause the problem of back-staining.

In the preparation procedures for EX40, the black colored polyester fabric was subjected to the first to third decolorizing treatments. The first and second decolorizing treatments were conducted using the used decolorizing solution, and the third decolorizing treatment was conducted using the decolorized solution which was obtained by subjecting the second used decolorizing solution obtained after the second decolorizing treatment to a distillation treatment, followed by mixing with a base. The decolorization rates of the first to third decolorizing treatments were 92.27%, 99.69%, and 99.74%, respectively. These results indicate that when the used decolorizing solution is used as a decolorizing solution, the black dye in the black colored polyester fabric can be almost entirely removed, and an excellent decolorization effect can be achieved. Therefore, the used decolorizing solution obtained after the decolorizing treatment can be reused, and will not cause the problem of back-staining.

In addition, the decolorization rate of the first decolorizing treatment was 92.27%, and the chromaticities of the decolorized polyester fabrics obtained from the first to third decolorizing treatments were shown to be declined persistently. These results indicate that since the used decolorizing solution has good decolorization ability, it is not necessary to use the unused decolorizing solution every time the decolorizing treatment is conducted, thereby reducing the amount of the unused decolorizing solution and reducing environmental pollution.

In the preparation procedures for EX46 to EX51, different types of colored polymer materials were subjected to the decolorizing treatment. The decolorized polymer materials of EX46 to EX51 had a chromaticity of not greater than 7.8 and a decolorization rate of not lower than 92.2%. These results indicate that the method for decolorizing a colored polymer material of the present disclosure can be applied to different types of colored polymer materials.

The experimental results of CE2 to CE18 are discussed below.

On the contrary, in the preparation procedures for CE2, the decolorizing solution contained no ketone solvent, and therefore the decolorized polyester fabric of CE2 had a high chromaticity and a low decolorization rate.

In the preparation procedures for CE3, the decolorizing solution contained sodium hydroxymethanesulfinate (SFS) and is without a ketone solvent and a base, and therefore the decolorized polyester fabric of CE3 had a high chromaticity and a low decolorization rate.

In the preparation procedures for CE4 and CE5 (i.e., the preparation procedures disclosed in US 10640914 B2), the decolorizing solution contained SFS and is without a base, and therefore under the same decolorizing treatment conditions, in comparison with the decolorized polyester fabric of EX32 which had a decolorization rate of 92.4%, the decolorization rates of the decolorized polyester fabrics of CE4 and CE5 were 81.4% and 85.2%, respectively. These results indicate that compared with the method for decolorizing a dye-colored synthetic polymer disclosed in US 10640914 B2, the method for decolorizing a colored polymer material of the present disclosure has excellent decolorization effect.

In the preparation procedures for CE6 (i.e., the preparation procedures disclosed in US 10640914 B2), the decolorizing solution contained SFS and is without a base. Although the decolorized polyester fabric of CE6 had a low chromaticity and a high decolorization rate, however, CE6 requires a high amount of the decolorizing solution (that is, the amount of SFS was 40 g, and the amount of the ketone solvent was 1000 mL, based on 1 L of water), and the weight ratio of water to the black colored polyester fabric was as high as 50. Therefore, under the same decolorizing treatment conditions, the decolorized polyester fabric of EX28 had the same or nearly the same chromaticity and decolorization rate. In the preparation procedures for EX28, the weight ratio of water to the black colored polyester fabric was 5.0275:1 (i.e., 25.1375 g:5 g), the amount of sodium hydroxide was 4.48 g, and the amount of cyclohexanone was 397.81 mL, based on 1 L of water. On the contrary, in the preparation procedures for CE6, the total amount of the decolorizing solution was high, thereby incurring a high cost and environmental pollution. These results indicate that compared with the method for decolorizing a dye-colored synthetic polymer disclosed in US 10640914 B2, the method for decolorizing a colored polymer material of the present disclosure has the advantages of low manufacturing cost and low risk of environmental pollution.

In comparison with the decolorizing solution of EX32 that contained sodium hydroxide and resultant decolorized polyester fabric of EX32 which had a decolorization rate of 92.4%, in the preparation procedures for CE7 and CE8, the decolorizing solution contained sodium dithionite and and is without a base, and under the same amount of acetone and the same temperature, the decolorized polyester fabrics of CE7 and CE8 had a high chromaticity and a low decolorization rate (only 84.5% and 87.7%, respectively). These results indicate that the decolorization effect of EX32 (which uses a decolorizing solution containing a base and a ketone solvent) is better than those of CE7 and CE8, and therefore the method for decolorizing a colored polymer material of the present disclosure has excellent decolorization effect.

In the preparation procedures for CE9 to CE11, alcohol solvents, i.e., ethanol, ethylene glycol, and n-butanol, were used in the decolorizing solutions of CE9 to CE11, respectively, and therefore the decolorized polyester fabrics of CE9 to CE11 had a high chromaticity and a low decolorization rate.

In comparison with the decolorizing solution of EX33 that contained sodium dithionite and the ketone solvent, in the preparation procedures for CE16 and CE17, the decolorizing solution contained sodium dithionite and is without a ketone solvent, and under the same amount of base, sodium dithionite, and water and the same decolorizing treatment conditions, the decolorized polyester fabrics of CE16 and CE17 had a decolorization rate of lower than 70%. These results indicate that the decolorization effect of EX33 (which uses a decolorizing solution containing a ketone solvent) is better than those of CE16 and CE17, and therefore the method for decolorizing a colored polymer material of the present disclosure has excellent decolorization effect.

Summarizing the above test results, it is clear that by virtue of the decolorizing treatment conditions and the decolorizing solution, the decolorized polymer material formed from the method for decolorizing a colored polymer material of the present disclosure has a low chromaticity and a high decolorization rate. In contrast to the conventional method, the decolorized polymer material with high decolorization rate can be obtained from the method for decolorizing a colored polymer material of the present disclosure by using a low amount of the decolorizing solution.

Moreover, in the conventional method, the colored polymer material needs to be depolymerized before being decolorized, but in the method of the present disclosure, the colored polymer material can be directly decolorized without additional depolymerization treatment. Furthermore, there is no problem of back-staining during the decolorizing treatment of the method of the present disclosure, even if the used decolorizing solution is used. Therefore, the method for decolorizing a colored polymer material of the present disclosure has excellent decolorization effect, and has advantages of low manufacturing cost and low risk of environmental pollution.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

1. A method for decolorizing a colored polymer material, comprising:
subjecting the colored polymer material to a first decolorizing treatment with a first decolorizing solution to remove a colorant from the colored polymer material, so as to obtain a first decolorized polymer material and a first used decolorizing solution;
wherein the first decolorizing treatment is conducted at a temperature of not less than 100° C. for a time period of not less than 30 minutes;
wherein the first decolorizing solution is selected from the group consisting of an unused decolorizing solution, a used decolorizing solution, and a decolorized solution, the first decolorizing solution including water, a ketone solvent, and a base;
wherein in the first decolorizing solution, the base is present in an amount ranging from 2 g to 10 g, the ketone solvent is present in an amount not lower than 30 mL, based on 1 L of water;
wherein a weight ratio of water to the colored polymer material is not lower than 5;
wherein the used decolorizing solution is obtained by subjecting the colored polymer material to at least one decolorizing treatment with the unused decolorizing solution or the decolorized solution; and
wherein the decolorized solution is obtained by subjecting the used decolorizing solution to a distillation treatment to obtain a distillate containing water and a ketone solvent, followed by mixing with a component containing a base.

2. The method according to claim 1, wherein in the first decolorizing solution, the ketone solvent is present in an amount ranging from 30 mL to 1000 mL, based on 1 L of water.

3. The method according to claim 1, wherein the first decolorizing solution has a pH value greater than 7.

4. The method according to claim 1, wherein the ketone solvent is selected from the group consisting of acetone, butanone, cyclopentanone, diisobutyl ketone, dipropyl ketone, cyclohexanone, and combinations thereof.

5. The method according to claim 1, wherein the base is selected from the group consisting of an alkali metal hydroxide and an alkali metal carbonate.

6. The method according to claim 1, wherein the first decolorizing solution further includes sodium dithionite.

7. The method according to claim 1, wherein the first decolorizing treatment is conducted at a temperature ranging from 100° C. to 130° C.

8. The method according to claim 1, wherein the first decolorizing treatment is conducted for a time period ranging from 30 minutes to 180 minutes.

9. The method according to claim 1, wherein the weight ratio of water to the colored polymer material ranges from 5:1 to 20:1.

10. The method according to claim 1, wherein the component further contains water.

11. The method according to claim 1, further comprising:
subjecting the first decolorized polymer material to a second decolorizing treatment with a second decolorizing solution so as to obtain a second decolorized polymer material and a second used decolorizing solution, the second decolorizing solution being selected from the group consisting of the first decolorizing solution and the first used decolorizing solution.

12. The method according to claim 11, wherein the temperature of the first decolorizing treatment is not less than the temperature of the second decolorizing treatment.

13. The method according to claim 11, further comprising:
subjecting the second decolorized polymer material to a third decolorizing treatment with a third decolorizing solution so as to obtain a third decolorized polymer material and a third used decolorizing solution, the third decolorizing solution being selected from the group consisting of the first decolorizing solution, the first used decolorizing solution, and the second used decolorizing solution.

14. The method according to claim 1, wherein the distillation treatment is conducted at a temperature ranging from 70° C. to 105° C., and based on 100 wt% of the distillate, the ketone solvent is present in an amount ranging from 30 wt% to 95 wt%.

15. A method for preparing a regenerated polymer, comprising:
subjecting a decolorized polymer material to a recycling treatment which is selected from the group consisting of a physical recycling treatment and a chemical recycling treatment,
wherein the decolorized polymer material is selected from the group consisting of a first decolorized polymer material as claimed in claim 1, a second decolorized polymer material further comprising:
subjecting the first decolorized polymer material to a second decolorizing treatment with a second decolorizing solution so as to obtain the second decolorized polymer material and a second used decolorizing solution, the second decolorizing solution being selected from the group consisting of the first decolorizing solution and the first used decolorizing solution, and a third decolorized polymer material further comprising:
subjecting the second decolorized polymer material to a third decolorizing treatment with a third decolorizing solution so as to obtain the third decolorized polymer material and a third used decolorizing solution, the third decolorizing solution being selected from the group consisting of the first decolorizing solution, the first used decolorizing solution, and the second used decolorizing solution.

16. The method according to claim 15, wherein the physical recycling treatment is conducted by subjecting the decolorized polymer material to a melting process, followed by a granulation process.

17. The method according to claim 1, wherein the chemical recycling treatment is conducted by subjecting the decolorized polymer material to a depolymerization reaction, a separation process, and a purification process in sequence so as to obtain a component containing a polymerizable monomer, followed by subjecting the component to a polymerization reaction.

18. A decolorizing solution comprising: water, a ketone solvent, and a base,
wherein in the decolorizing solution, the base is present in an amount ranging from 2 g to 10 g, the ketone solvent is present in an amount not lower than 30 mL, based on 1 L of water.

19. The decolorizing solution according to claim 18, wherein the ketone solvent is present in an amount ranging from 30 mL to 1000 mL, based on 1 L of water.

20. The decolorizing solution according to claim 18, further comprising sodium dithionite.

21. The decolorizing solution according to claim 20, wherein sodium dithionite is present in an amount ranging from 1 g to 10 g, based on 1 L of water.

22. The decolorizing solution according to claim 18, which has a pH value greater than 7.

23. The decolorizing solution according to claim 18, wherein the ketone solvent is selected from the group consisting of acetone, butanone, cyclopentanone, diisobutyl ketone, dipropyl ketone, cyclohexanone, and combinations thereof.

24. The decolorizing solution according to claim 18, wherein the base is selected from the group consisting of an alkali metal hydroxide and an alkali metal carbonate.
